(19) United States
(12) Patent Application Publication
(10) Pub. No.: US 2025/0392005 A1
(43) Pub. Date: Dec. 25, 2025

(54) ALL-SOLID-STATE BATTERY

(71) Applicant: SAMSUNG SDI CO., LTD., Yongin-si, Gyeonggi-do (KR)

(72) Inventors: Isaac SHIN, Yongin-si, Gyeonggi-do (KR); Riyul KIM, Yongin-si, Gyeonggi-do (KR); Kwang Jong SUH, Yongin-si, Gyeonggi-do (KR); Young Gyoon RYU, Yongin-si, Gyeonggi-do (KR); Ik Hwan CHO, Yongin-si, Gyeonggi-do (KR)

(21) Appl. No.: 18/878,953

(22) PCT Filed: Jan. 5, 2024
(86) PCT No.: PCT/KR2024/000291

§ 371 Date: Dec. 26, 2024

(30) Foreign Application Priority Data
Mar. 10, 2023 (KR) 10-2023-0032014

(51) Int. Cl. H01M 50/48; H01M 50/46; H01M 50/474

(52) U.S. Cl. CPC H01M 50/48; H01M 50/46; H01M 50/474

(57) ABSTRACT

An all-solid-state battery according to an embodiment includes unit cells each including a positive electrode plate, a solid electrolyte layer stacked on one side of the positive electrode plate, and a negative electrode plate stacked on one side of the solid electrolyte layer, and elastic sheets stacked between the unit cells and on an outer side of an outermost unit cell, wherein the elastic sheets have different pore densities with respect to a stacking direction.

### TECHNICAL FIELD

The present disclosure relates to an all-solid-state battery, and more particularly, to an all-solid-state battery including a positive electrode plate, a solid electrolyte layer, a negative electrode plate, and an elastic sheet.

### BACKGROUND ART

Recently, as the risk of explosion of a battery using a liquid electrolyte has been reported, development of batteries using solid electrolytes is being actively conducted. An all-solid-state battery undergoes volume changes during charging and discharging, and an elastic sheet can be used to buffer such volume changes.

### DISCLOSURE

### Technical Problem

The present disclosure attempts to provide an all-solid-state battery in which an elastic sheet, which provides stress relief and elastic force, is formed as a single layer.

### Technical Solution

An all-solid-state battery according to an embodiment includes unit cells each including a positive electrode plate, a solid electrolyte layer stacked on one side of the positive electrode plate, and a negative electrode plate stacked on one side of the solid electrolyte layer; and elastic sheets stacked between the unit cells and on an outer side of an outermost unit cell, wherein the elastic sheets have different pore densities with respect to a stacking direction.

The elastic sheets may each be formed as a two-layer structure and include a base material layer formed of a sheet base material and a porous layer having pores on one side of the base material layer.

The elastic sheet may be stacked with the porous layer positioned on the outer side of the outermost unit cell.

The elastic sheets may each be formed as a three-layer structure and include a base material layer formed of a sheet base material at a center of the three-layer structure and a first porous layer and a second porous layer having pores on both sides of the base material layer.

The elastic sheets may each be stacked between two adjacent unit cells, with the first porous layer positioned on a unit cell on one side of the two unit cells and the second porous layer positioned on a unit cell on the other side.

The elastic sheets may include a two-layer structure sheet including a porous layer on one side of a base material layer, and a three-layer structure sheet including a first porous layer and a second porous layer on both sides of a base material layer.

The two-layer structure sheet may be arranged on the outer side of the outermost unit cell, with the porous layer positioned on a side facing the outermost unit cell, and the base material layer positioned on a side away from the outermost unit cell.

The three-layer structure sheet may be arranged between the unit cells, with the first porous layer and the second porous layer positioned on sides facing the unit cells, and the base material layer positioned on a center side away from the unit cells.

The elastic sheets may include a two-layer structure sheet including a porous layer on one side of a base material layer, and a single-layer structure sheet having pores throughout an entire region of a base material layer.

The two-layer structure sheet may be arranged on the outer side of the outermost unit cell, and the single-layer structure sheet may be arranged between the unit cells.

The elastic sheets may include a single-layer structure sheet having pores throughout an entire region of a base material layer, and a three-layer structure sheet including a first porous layer and a second porous layer on both sides of a base material layer.

The single-layer structure sheet may be arranged on the outer side of the outermost unit cell, and the three-layer structure sheet may be arranged between the unit cells.

### Advantageous Effects

The all-solid-state battery according to the embodiment includes the elastic sheets stacked between the unit cells and on the outer side of the outermost unit cell and configured to have different pore densities with respect to the stacking direction, thereby allowing for stress relief and provision of elastic force with a single sheet. That is, portions of the elastic sheets with high pore density can relieve stress during charging, and portions with low pore density can provide elastic force during discharging.

### DESCRIPTION OF THE DRAWINGS

FIG. 1 is a cross-sectional view of an all-solid-state battery according to a first embodiment of the present disclosure.

FIG. 2 is a cross-sectional view of a unit cell applied to FIG. 1.

FIG. 3 is a cross-sectional view of another unit cell applied to FIG. 1.

FIG. 4 is a cross-sectional view of an all-solid-state battery according to a second embodiment of the present disclosure.

FIG. 5 is a cross-sectional view of an all-solid-state battery according to a third embodiment of the present disclosure.

FIG. 6 is a cross-sectional view of an all-solid-state battery according to a fourth embodiment of the present disclosure.

FIG. 7 is a cross-sectional view of an all-solid-state battery according to a fifth embodiment of the present disclosure.

### MODE FOR INVENTION

Hereinafter, the present disclosure will be described more fully hereinafter with reference to the accompanying drawings, in which embodiments of the invention are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

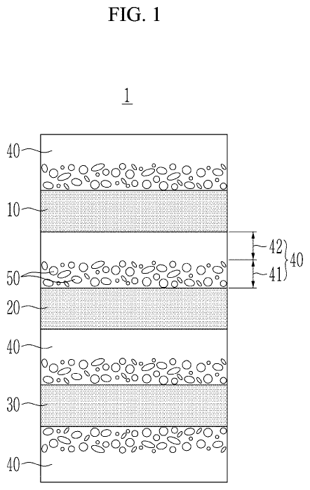

FIG. 1 is a cross-sectional view of an all-solid-state battery according to a first embodiment of the present disclosure. Referring to FIG. 1, an all-solid-state battery 1 of the first embodiment includes a plurality of unit cells 10, 20, and 30 and elastic sheets 40 stacked between the unit cells 10, 20, and 30 and on outer sides of outermost unit cells 10 and 30. For convenience, three unit cells 10, 20, and 30 are illustrated.

The unit cells 10, 20, and 30 may be formed as mono-cells or bi-cells. The elastic sheet 40 is constituted as a single sheet and is configured to contact the unit cells 10, 20, and 30, which undergo volume changes during charging and discharging, thereby providing two functions of relieving stress during charging and providing elastic force during discharging.

An elastic sheet of a Comparative Example may be configured to have the characteristics of stress relief and provision of elastic force provision by stacking an elastic sheet with pores and an elastic sheet without pores. The elastic sheet 40 composed of a single sheet can prevent additional processes and an increase in minimum thickness, which are required in the Comparative Example. Additionally, in the Comparative Example of stacking two elastic sheets, air bubble traps may be generated between the two elastic sheets. The elastic sheet 40 composed of a single sheet can eliminate air bubble traps.

The elastic sheet 40 has different pore densities with respect to a stacking direction (vertical direction in FIG. 1). The fact that the elastic sheet 40 has different pore densities along the stacking direction means that the pore density inside the elastic sheet varies continuously or discontinuously along the stacking direction of the battery. For example, in FIG. 1, there are many pores on a lower side in the vertical direction, resulting in a high pore density, and there are no pores on an upper side, resulting in a low pore density.

In the first embodiment, the elastic sheet 40 is formed as a two-layer structure and includes a porous layer 41 and a base material layer 42. The base material layer 42 is formed of a sheet base material and does not have pores. The porous layer 41 is provided on one side of the base material layer 42 and is formed by providing pores 50 in the base material. In addition, although not shown, the base material layer may have pores with a relatively lower density than that of the porous layer.

A thickness of the all-solid-state battery 1 changes during charging and discharging. In this regard, the porous layer 41 having pores 50 in the base material relieves stress caused by the increasing thickness of the all-solid-state battery 1 at a contact surface during charging. The base material layer 42 provides elastic force to restore the decreasing thickness of the all-solid-state battery 1 at the contact surface during discharging. The stress relief can be effective when it is close to the surface of the all-solid-state battery 1, while the elastic force can be effective even when it is not close to the surface of the all-solid-state battery 1.

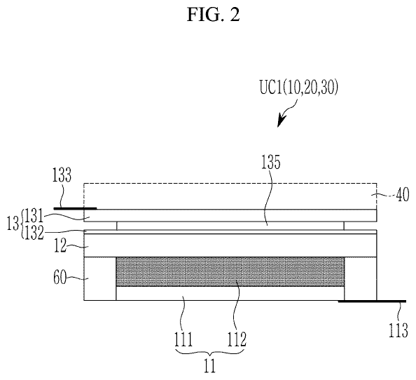

FIG. 2 is a cross-sectional view of a unit cell applied to FIG. 1. As an example, referring to FIG. 2, the unit cell 10, 20, 30 may be formed as a mono-cell UC1 that performs charging and discharging on one side of a positive electrode plate 11.

The mono-cell UC1 includes a positive electrode plate 11, a solid electrolyte layer 12 arranged on one side of the positive electrode plate 11, and a negative electrode plate 13 arranged on one side of the solid electrolyte layer 12. The positive electrode plate 11 includes a positive electrode active material layer 112 on one surface of a positive electrode current collector 111 made of aluminum.

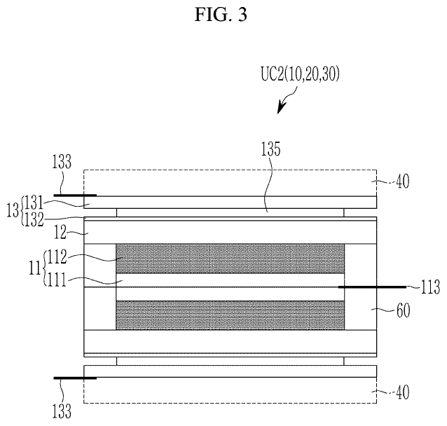

FIG. 3 is a cross-sectional view of another unit cell applied to FIG. 1. As an example, referring to FIG. 3, another unit cell 10, 20, 30 may be formed as a bi-cell UC2 that performs charging and discharging on both sides of the positive electrode plate 11. In the bi-cell UC2, the positive electrode plate 11 includes positive electrode active material layers 112 on both sides of the positive electrode current collector 111 made of aluminum.

Referring to FIGS. 2 and 3, a lithium precipitation layer 135 is absent in a discharge state but is formed when lithium ions migrate from the positive electrode plate 11 and precipitate on one surface of a negative electrode current collector 131 in the charge state, thereby increasing the thickness of the all-solid-state battery 1. During discharging, lithium ions in the lithium precipitation layer 135 are deintercalated from the negative electrode current collector 131 and migrate to the positive electrode plate 11, causing the lithium precipitation layer 135 to disappear from the negative electrode current collector 131, thereby reducing the thickness of the all-solid-state battery 1.

The negative electrode plate 13 includes a negative electrode active material layer 132 on a one surface of the negative electrode current collector 131 made of stainless steel (SUS) or nickel-coated copper (Ni-coated Cu). For convenience, the negative electrode active material layer 132 is illustrated here, but the negative electrode active material layer 132 may not be provided. In this case, the precipitated lithium precipitation layer 135 acts as a negative electrode active material layer.

As an example, the positive electrode plate 11 has a uncoated portion 113 protruding to one side, and the negative electrode plate 13 has an uncoated portion 133 protruding to the other side. The unit cell UC1, UC2 further includes a finish member 60. The finish member 60 is configured to enable extraction of the uncoated portion 113 while surrounding the periphery of the positive electrode plate 11.

Referring again to FIG. 1, the elastic sheets 40 are stacked with the porous layers 41 positioned on the outer sides of the outermost unit cells 10 and 30. That is, the porous layers 41 of the elastic sheets 40 primarily relieve stress on the outer sides of the outermost unit cells 10 and 30 and secondarily provide elastic force. As an example, the elastic sheet 40 may be formed of a polyethylene (PE) fabric or a polypropylene (PP) fabric.

Referring to FIGS. 3 and 1, the unit cells 10, 20, and 30 are bi-cells. The elastic sheet 40 is arranged on a back surface of the negative electrode collector 131 of the negative electrode plate 13 with respect to each of the outermost unit cells 10 and 30. During charging, the elastic sheet 40 relieves stress through the porous layer 41, in response to the increasing thickness due to the formation of the lithium precipitation layer 135 as lithium precipitates on the negative electrode active material layer 132 and the negative electrode current collector 131.

In addition, during discharging, the elastic sheet 40 provides elastic force through the base material layer 42, in response to the decreasing thickness due to the disappearance of the lithium precipitation layer 135 as lithium is intercalated from the negative electrode active material layer 132 and the negative electrode current collector 131.

The elastic sheets 40 arranged on both surfaces of the intermediate unit cell 20 are arranged between the negative electrode current collectors 131 of the two negative electrode plates 13 on both sides. During charging, the two elastic sheets 40 relieve stress through the near porous layer 41 and the far porous layer 41, in response to the increasing thickness due to the formation of the lithium precipitation layer 135 as lithium precipitates on the negative electrode active material layer 132 and the negative electrode current collector 131.

In addition, during discharging, the two elastic sheets 40 provide elastic force through the near base material layer 42 and the far base material layer 42, in response to the decreasing thickness due to the disappearance of the lithium precipitation layer 135 as lithium is intercalated from the negative electrode active material layer 132 and the negative electrode current collector 131.

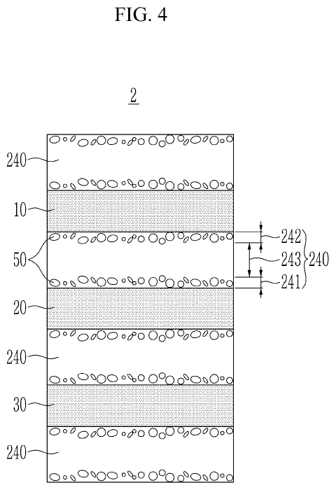

FIG. 4 is a cross-sectional view of an all-solid-state battery according to a second embodiment of the present disclosure. Referring to FIG. 4, in an all-solid-state battery 2 of the second embodiment, an elastic sheet 240 is formed as a three-layer structure and includes a base material layer 243, a first porous layer 241, and a second porous layer 242.

The base material layer 243 is formed of a sheet base material at a center of the three-layer structure and does not have pores. The first porous layer 241 and the second porous layer 242 are provided on both sides of the base material layer 243, respectively, and are formed by providing pores 50 in the base material. In addition, although not shown, the base material layer may have pores with a relatively lower density than those of the first and second porous layers.

The first and second porous layers 241 and 242 on the upper and lower sides have the same physical properties, and the intermediate base material layer 243 has different physical properties from those of the first and second porous layers on the upper and lower sides. The first and second porous layers 241 and 242 relieve stress caused by the increasing thickness during charging through the numerous pores 50. The base material layer 243, lacking the pores 50, provides elastic force according to the physical properties of the base material to restore the decreasing thickness during discharging.

Such elastic sheets 240 are arranged between the unit cells 10, 20, and 30. Between them, the first and second porous layers 241 and 242 correct uneven points of the unit cells 10, 20, and 30 to relieve the stress caused by the increase in thickness during charging, and the base material layer 243 can provide elastic force to restore the reduced thickness during discharging.

As an example, the elastic sheet 240 is stacked between two adjacent unit cells 10, 20, and 30 with, for example, the first porous layer 241 positioned on the unit cell 10 on one side of the two unit cells 10 and 20 and the second porous layer 242 positioned on the unit cell 20 on the other side.

Referring to FIGS. 3 and 4, the unit cells 10, 20, and 30 are bi-cells. The elastic sheet 240 is arranged on a back surface of the negative electrode collector 131 of the negative electrode plate 13 with respect to each of the outermost unit cells 10 and 30. During charging, the elastic sheet 240 relieves stress through the first and second porous layer 241 and 242, in response to the increasing thickness due to the formation of the lithium precipitation layer 135 as lithium precipitates on the negative electrode active material layer 132 and the negative electrode current collector 131.

In addition, during discharging, the elastic sheet 240 provides elastic force through the base material layer 243, in response to the decreasing thickness due to the disappearance of the lithium precipitation layer 135 as lithium is intercalated from the negative electrode active material layer 132 and the negative electrode current collector 131.

The elastic sheets 240 arranged on both surfaces of the intermediate unit cell 20 are arranged between the negative electrode current collectors 131 of the two negative electrode plates 13 on both sides. During charging, the two elastic sheets 40 relieve stress through the close first porous layer 241 and second porous layer 242, respectively, in response to the increasing thickness due to the formation of the lithium precipitation layer 135 as lithium precipitates on the negative electrode active material layer 132 and the negative electrode current collector 131.

In addition, during discharging, the two elastic sheets 240 provide elastic force through the far base material layer 243 and base material layer 243, respectively, in response to the decreasing thickness due to the disappearance of the lithium precipitation layer 135 as lithium is intercalated from the negative electrode active material layer 132 and the negative electrode current collector 131.

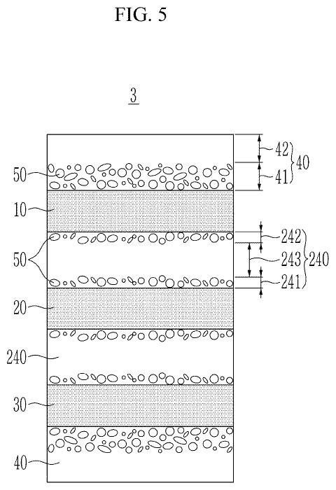

FIG. 5 is a cross-sectional view of an all-solid-state battery according to a third embodiment of the present disclosure. Referring to FIG. 5, in the all-solid-state battery 3 of the third embodiment, the elastic sheet includes a two-layer structure sheet and a three-layer structure sheet.

The two-layer structure sheet is formed as an elastic sheet 40 of a two-layer including the porous layer 41 on one side of the base material layer 42. The three-layer structure sheet is formed as an elastic sheet 240 of a three-layer structure including the first porous layer 241 and the second porous layer 242 on both sides of the base material layer 243.

The elastic sheet of the third embodiment includes the elastic sheet 40 of the first embodiment and the elastic sheet 240 of the second embodiment. Therefore, the all-solid-state battery 3 of the third embodiment includes the unit cells 10, 20, and 30, the elastic sheet 40 of a two-layer structure, and the elastic sheet 240 of a three-layer structure.

The elastic sheet 40 of a two-layer structure is arranged on the outer side of each of the outermost unit cells 10 and 30, with the porous layer 41 positioned on a side facing each of the outermost unit cells 10 and 30, and the base material layer 42 positioned on a side away from each of the outermost unit cells 10 and 30. The elastic sheet 40 of a two-layer structure relieves stress due to the increasing thickness during charging and provides elastic force to restore the decreasing thickness during discharging, as in the first embodiment.

The elastic sheet 240 of a three-layer structure is arranged between the unit cells 10, 20, and 30, with the first porous layer 241 and the second porous layer 242 positioned on sides facing the unit cells 10, 20, and 30, and the base material layer 243 positioned on a center side away from the unit cells 10, 20, and 30. The elastic sheet 240 of a three-layer structure relieves stress due to the increasing thickness during charging and provides elastic force to restore the decreasing thickness during discharging, as in the second embodiment.

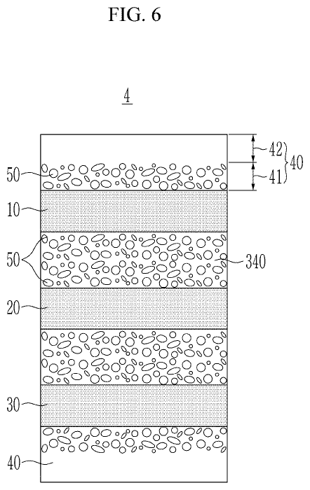

FIG. 6 is a cross-sectional view of an all-solid-state battery according to a fourth embodiment of the present disclosure. Referring to FIG. 6, in an all-solid-state battery 4 of the fourth embodiment, the elastic sheet includes a two-layer structure sheet and a single-layer structure sheet.

The two-layer structure sheet is formed as an elastic sheet 40 of a two-layer including the porous layer 41 on one side of the base material layer 42. The single-layer structure sheet is formed as an elastic sheet 340 of a single-layer structure having pores 50 throughout an entire region of the base material layer. Since the elastic sheet 340 is uniformly filled with the pores 50 throughout the entire region of the base material layer, it has almost the same physical properties, i.e., similar stress relief and similar elastic force, in the stacking direction (vertical direction).

The elastic sheet of the fourth embodiment includes the elastic sheet 340 provided separately from the elastic sheet 40 of the first embodiment. Therefore, the all-solid-state battery 4 of the fourth embodiment includes the unit cells 10, 20, and 30, the elastic sheet 40 of a two-layer structure, and the elastic sheet 340 of a single-layer structure.

The elastic sheet 40 of a two-layer structure is arranged on the outer side of each of the outermost unit cells 10 and 30, with the porous layer 41 positioned on a side facing each of the outermost unit cells 10 and 30, and the base material layer 42 positioned on a side away from each of the outermost unit cells 10 and 30. The elastic sheet 340 of a single-layer structure relieves stress due to the increasing thickness during charging and provides elastic force to restore the decreasing thickness during discharging, as in the first embodiment.

The elastic sheet 340 of a single-layer structure is arranged between the unit cells 10, 20, and 30, and in this case, relieves stress caused by the increasing thickness during charging between the unit cells 10, 20, and 30 through the pores 50 and provides elastic force to restore the decreasing thickness during discharging through the base material portion without the pores 50.

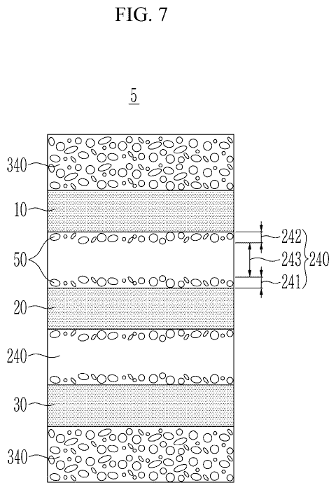

FIG. 7 is a cross-sectional view of an all-solid-state battery according to a fifth embodiment of the present disclosure. Referring to FIG. 7, in an all-solid-state battery 5 of the fifth embodiment, the elastic sheet includes a single-layer structure sheet and a three-layer structure sheet.

The elastic sheet of the fifth embodiment includes the elastic sheet 340 of the fourth embodiment and the elastic sheet 240 of the second embodiment. Therefore, the all-solid-state battery 5 of the fifth embodiment includes the unit cells 10, 20, and 30, the elastic sheet 340 of a single-layer structure, and the elastic sheet 240 of a three-layer structure.

The elastic sheet 340 of a single-layer structure is arranged on the outer side of each of the outermost unit cells 10 and 30, and in this case, relieves stress caused by the increasing thickness during charging in the outermost unit cells 10 and 30 through the pores 50 and provides elastic force to restore the decreasing thickness during discharging through the base material portion without the pores 50.

The elastic sheet 240 of a three-layer structure is arranged between the unit cells 10, 20, and 30, with the first porous layer 241 and the second porous layer 242 positioned on sides facing the unit cells 10, 20, and 30, and the base material layer 243 positioned on a center side away from the unit cells 10, 20, and 30. The elastic sheet 240 of a three-layer structure relieves stress caused by the increasing thickness during charging and provides elastic force to restore the decreasing thickness during discharging, as in the second embodiment.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

[Reference Signs List]

| | |
|---|---|
| 1, 2, 3, 4, 5: all-solid-state battery | 10, 20, 30: unit cell |
| 11: positive electrode plate | 12: solid electrolyte layer |
| 13: negative electrode plate | 40: elastic sheet |
| 41: porous layer | 42: base material layer |
| 50: pore | 60: finish member |
| 111: positive electrode current collector | |
| 112: positive electrode active | |
| material layer | |
| 113: uncoated portion | 131: negative electrode |
| | current collector |
| 132: negative electrode active | 133: uncoated portion |
| material layer | |
| 135: lithium precipitation layer | 240: elastic sheet |
| 241: first porous layer | 242: second porous layer |
| 243: base material layer | 340: elastic sheet |
| UC1: mono-cell | UC2: bi-cell |

1. An all-solid-state battery comprising:
unit cells each comprising a positive electrode plate, a solid electrolyte layer stacked on one side of the positive electrode plate, and a negative electrode plate stacked on one side of the solid electrolyte layer; and
elastic sheets stacked between the unit cells and on an outer side of an outermost unit cell,
wherein the elastic sheets
have different pore densities with respect to a stacking direction.

2. The all-solid-state battery of claim 1, wherein:
the elastic sheets are each formed as a two-layer structure and comprises
a base material layer formed of a sheet base material and
a porous layer having pores on one side of the base material layer.

3. The all-solid-state battery of claim 2, wherein:
the elastic sheet is
stacked with the porous layer positioned on the outer side of the outermost unit cell.

4. The all-solid-state battery of claim 1, wherein:
the elastic sheets are each formed as a three-layer structure and comprises
a base material layer formed of a sheet base material at a center of the three-layer structure and
a first porous layer and a second porous layer having pores on both sides of the base material layer.

5. The all-solid-state battery of claim 4, wherein:
the elastic sheets are each
stacked between two adjacent unit cells, with the first porous layer positioned on a unit cell on one side of the two unit cells and the second porous layer positioned on a unit cell on the other side.

6. The all-solid-state battery of claim 1, wherein:
the elastic sheets comprise
a two-layer structure sheet comprising a porous layer on one side of a base material layer, and
a three-layer structure sheet comprising a first porous layer and a second porous layer on both sides of a base material layer.

7. The all-solid-state battery of claim 6, wherein:
the two-layer structure sheet is arranged on the outer side of the outermost unit cell,
with the porous layer positioned on a side facing the outermost unit cell, and
the base material layer positioned on a side away from the outermost unit cell.

8. The all-solid-state battery of claim 6, wherein:
the three-layer structure sheet is arranged between the unit cells,
with the first porous layer and the second porous layer positioned on sides facing the unit cells, and
the base material layer positioned on a center side away from the unit cells.

9. The all-solid-state battery of claim 1, wherein:
the elastic sheets comprise
a two-layer structure sheet comprising a porous layer on one side of a base material layer, and
a single-layer structure sheet having pores throughout an entire region of a base material layer.

10. The all-solid-state battery of claim 9, wherein:
the two-layer structure sheet is arranged on the outer side of the outermost unit cell, and
wherein the single-layer structure sheet is arranged between the unit cells.

11. The all-solid-state battery of claim 1, wherein:
the elastic sheets comprise
a single-layer structure sheet having pores throughout an entire region of a base material layer, and
a three-layer structure sheet comprising a first porous layer and a second porous layer on both sides of a base material layer.

12. The all-solid-state battery of claim 11, wherein:
the single-layer structure sheet is arranged on the outer side of the outermost unit cell, and
wherein the three-layer structure sheet is arranged between the unit cells.
